(19) United States
(12) Patent Application Publication
(10) Pub. No.: US 2014/0184350 A1
(43) Pub. Date: Jul. 3, 2014

(54) TWO LAYER DIFFERENTIAL PAIR LAYOUT, AND METHOD OF MAKING THEREOF, FOR REDUCED CROSSTALK

(71) Applicant: Gregory Eric Howard, Plano, TX (US)

(72) Inventor: Gregory Eric Howard, Plano, TX (US)

(73) Assignee: TEXAS INSTRUMENTS INCORPORATED, Dallas, TX (US)

(21) Appl. No.: 13/728,468

(22) Filed: Dec. 27, 2012

(51) Int. Cl. H01P 3/08; H01P 11/00

(52) U.S. Cl. CPC H01P 3/08; H01P 11/003
USPC 333/5; 333/238; 427/97.3

(57) ABSTRACT

A device is provided for use with a signal, wherein the device includes a substrate, a first signal trace and a second signal trace. The first signal trace is disposed within the substrate at a first plane from the top surface by a distance d₁. The second signal trace is disposed within the substrate at a second plane from the top surface by a distance d₂, wherein d₂<d₁<t. The first signal trace includes a first portion, whereas the second signal trace includes a second portion. The first portion is parallel to the second portion. The first signal trace and the second signal trace form a differential pair. The first signal trace is operable to conduct a positive portion of the signal, whereas the second signal trace is operable to conduct a negative portion of the signal.

### BACKGROUND

The operating speeds of semiconductor devices have continued to increase and continuously push the limit of conventional packaging technology.

To support the ever increasing operation speed of semiconductor devices, a differential pair is often used. A differential pair is a pair of conductors used for differential signaling. A differential pair reduces crosstalk and electromagnetic interference and can provide constant and/or known characteristic impedance. Furthermore, a differential pair enables impedance matching techniques used for high-speed signal transmission lines. Non-limiting examples of a differential pair include twisted-pair, microstrip and stripline.

A differential pair reduces the total current between the two conductors of the differential pair, as Kirchhoff's predicts the total current as being zero through a cross section of the differential pair. The condition for emitting zero electromagnetic interference representing zero crosstalk is for zero total inductive and capacitive coupling through the cross section of the differential pair at the input and output of the differential pairs. However, in real world situations, the total coupling approaches zero but zero coupling is not achieved, resulting in crosstalk between the conductors of a differential pair.

Additionally, crosstalk may occur between differential pairs as a result of second-order effects due to the finite impedance of the current source and impedance mismatch between the devices. For this case, the two conductors of the differential pair may be considered as a dipole with coupling on the order of 1/r² or 1/r⁴, where r is the distance between lines of differential pairs. To reduce crosstalk, the effects associated with second-order effects need to be reduced.

The differential to differential pair crosstalk in electronic equipment limits its applicability to higher than 5 GHz types of Serializer/Deserializer (Serdes) designs. The crosstalk between differential pairs needs to be kept to a level of around −60 dB or less in order to minimize its impact on the channels ability to receive a greatly attenuated signal. Modern signal channels at high speed can introduce an attenuation of 40 dB or more. To properly receive such a signal in the presence of a fully duplexed communication stream, a cross-coupling immunity of 60 dB is needed for reliable signal reception.

The coupling between differential pairs is due to an imbalance in the coupling from between conductors in the differential pair configuration. As an example of the imbalance, a 1 Volt signal may be traversing a leg of a differential pair and a 10 mV signal may be traversing a leg of a different differential pair.

The crosstalk between differential pairs is known/deterministic and can be calculated.

In order to determine the crosstalk between differential pairs, the mutual inductance is calculated. The mutual inductance by a filamentary circuit i on a filamentary (consisting of wires and rods) circuit is given by the double integral Neumann formula as give by Equation 1 below:

$${M}_{ij} = \frac{{μ}_{0}}{4 π} {∮}_{Ci} {∮}_{Cj} \frac{d {s}_{i} \cdot d {s}_{j}}{\vert {R}_{ij} \vert} \qquad ( 1 )$$

Where μ₀ denotes the magnetic constant (4π×10⁻⁷ H/m), Cᵢ and Cⱼ are the curves spanned by the wires, Rᵢⱼ is the distance between two points.

The currents associated with the positive and negative conductors of a differential have the same magnitude of current but traversing in opposing directions.

Differential pair to differential pair crosstalk is a technology limiter that causes system failure in the form of signal detection error—increasing the system jitter and causing the signal detection eye pattern to close. An eye pattern, also known as an eye diagram, is a presentation (e.g. oscilloscope display) of a digital data signal as received at a receiver. Furthermore, the received signal is repetitively sampled and applied to the vertical input, while the data rate is used to trigger the horizontal sweep.

Reduction of this crosstalk is possible using a technique known as orthogonal crossovers. The use of crossovers between differential pairs introduces significant discontinuities in the transmission lines that make up the differential pairs. A significant source of the discontinuities is a result of the vias that are used to move the pair from one side to the other. A via in an integrated circuit or printed circuit board is a means for transferring a signal from one signal layer to another signal layer.

Alternate means used to reduce the reflections from the crossovers include designing the via structure in such a way as to match the characteristic impedance of the line.

FIGS. 1A-C illustrates an example conventional transmission line system 100.

Transmission line system 100 includes a differential pair 102 and a differential pair 104.

Differential pair 102 provides a transmission medium for transferring an electrical signal. Differential pair 104 provides a transmission medium for transferring an electrical signal. A differential pair is a par of conductors used for differential signaling. A differential pair reduces crosstalk and electromagnetic interference and can provide constant and/or known characteristic impedance. Furthermore, a differential pair enables impedance matching techniques used for high-speed signal transmission lines. Non-limiting examples of a differential pair include twisted-pair, microstrip and stripline.

Differential pair 102 includes a positive signal trace 106 and a negative signal trace 108. Differential pair 104 includes a positive signal trace 110 and a negative signal trace 112. In some embodiments, the positive signal associated with positive signal trace 106 is equal and opposite to the negative signal associated with negative signal trace 108. In other embodiments, the positive signal associated with positive signal trace 106 is different in magnitude to the negative signal associated with negative signal trace 108. In theory, for embodiments with equal but opposite signals associated with positive signal trace 106 and negative signal trace 108, the radiant electromagnetic field generated by the positive signal in positive signal trace 106 is cancelled by the equal and opposite radiant electromagnetic field generated by the negative signal in negative signal trace 108. Similarly, for some embodiments, the positive signal in positive signal trace 110 is equal and opposite to the negative signal in negative signal trace 112. In theory, radiant electromagnetic field generated by the positive signal in positive signal trace 110 is cancelled by the equal and opposite radiant electromagnetic field generated by the negative signal in negative signal trace 112.

The radiant effects of current through a differential pair may negatively affect the signals in an adjacent (or nearby) differential pair. In particular, a current traveling through one signal trace may affect the current traveling through another signal trace, wherein the magnitude is a function of distance. For example, current traveling through positive signal trace 106 will affect current traveling through positive signal trace 110, and will also affect current traveling through negative signal trace 112, but by a slightly less amount. Further, current traveling through negative signal trace 108 will affect current traveling through positive signal trace 110, and will also affect current traveling through negative signal trace 112, but by a slightly less amount. The overall effect is crosstalk interference, or crosstalk.

The total effects of crosstalk may be determined by integrating the effect along a length of the crosstalk, in this instance a length 114 noted as L. To simplify the discussion, first consider the effects of positive signal trace 106 and negative signal trace 108 on positive signal trace 110. Then, consider the effects of positive signal trace 106 and negative signal trace 108 on negative signal trace 112. This will be further described with reference to FIGS. 1B-C.

FIG. 1B takes into account the effects of currents of positive signal trace 106 and negative signal trace 108, as felt by positive signal trace 110. In this example, negative signal trace 108 and is separated from positive signal trace 110 by a distance 116 noted as r₁, whereas positive signal trace 106 and is separated from positive signal trace 110 by a distance 118 noted as r₂. The radiant effects of currents of positive signal trace 106, as felt by positive signal trace 110, are opposite to the radiant effects of currents of negative signal trace 108, as felt by positive signal trace 110. However, distance 116 is smaller than distance 118. Accordingly, the radiant effects of currents of negative signal trace 108, as felt by positive signal trace 110 are greater than the radiant effects of currents of positive signal trace 106.

FIG. 1C takes into account the effects of currents of positive signal trace 106 and negative signal trace 108, as felt by negative signal trace 112. In this example, negative signal trace 108 and is separated from negative signal trace 112 by distance 118 (again noted as r₂), whereas positive signal trace 106 and is separated from negative signal trace 112 by a distance 120 noted as r₃. The radiant effects of currents of positive signal trace 106, as felt by negative signal trace 112, are opposite to the radiant effects of currents of negative signal trace 108, as felt by negative signal trace 112. However, distance 118 is smaller than distance 120. Accordingly, the radiant effects of currents of negative signal trace 108, as felt by negative signal trace 112 are greater than the radiant effects of currents of positive signal trace 106 as felt by negative signal trace 112.

Comparing the situations illustrated in FIGS. 1B-C, it is clear that the radiant effects of currents of positive signal trace 106 as felt by positive signal trace 110 (as shown in FIG. 1B) is equal and opposite to the radiant effects of currents of negative signal trace 108 as felt by negative signal trace 112 (as shown in FIG. 1C). Accordingly, the radiant effects effectively cancel.

The remaining radiant effects are therefore drawn to the radiant effect of current of negative signal trace 108 as felt by positive signal trace 110 (as shown in FIG. 1B) in addition to the radiant effect of current of positive signal trace 106 as felt by negative signal trace 112 (as shown in FIG. 1C). Ideally, the current in positive signal trace 110 should be equal and opposite to the current in negative signal trace 112. However, radiant effect of current of negative signal trace 108 alter the current in positive signal trace 110, whereas the radiant effect of current of positive signal trace 106 will alter the negative signal trace 112. For simplicity of explanation, let the “alteration” the current in positive signal trace 110 be an attenuation, and let of the “alteration” the current in positive signal trace 110 additionally be an attenuation. The attenuation of the signal in negative signal trace 112 is less than the attenuation of the signal in positive signal trace 110 because r₂<r₃. The difference in interference creates a distortion in the signal if positive signal trace 110 and negative signal trace 112 are attenuated differently. Even though the interference may be minor, the interference calculation is integrated over the length of distance 114 or L as described by Equation 1.

In order to reduce crosstalk, conventional systems cross or switch conductors of a differential pair in order to balance the coupling between the differential pairs which will be further discussed with reference to FIG. 2.

FIG. 2 illustrates an example conventional transmission line system 200, wherein one set of signal traces include a crossover.

As shown in the figure, prior to a crossover point 206, positive signal trace 110 is separated from negative signal trace 108 by distance 116 (indicated by r₁), whereas negative signal trace 112 is separated from positive signal trace 106 by distance 120 (indicated by r₃). After crossover point 206, negative signal trace 112 is separated from negative signal trace 108 by distance 116 (indicated by r₁), whereas positive signal trace 110 is separated from positive signal trace 106 by distance 120 (indicated by r₃). For purposes of discussion, let crossover point 206 be in the middle of distance L.

The radiant effects of the current of negative signal trace 108 as felt by positive signal trace 110 from the left of the figure to crossover point 206 is equal in magnitude and opposite in sign to the radiant effects of the current of negative signal trace 108 as felt by negative signal trace 112 crossover point 206 to the right of the figure. Accordingly, the radiant effects of the current from the left side of the figure to the right side of the figure cancel each other out. Similarly, the radiant effects of the current of positive signal trace 106 as felt by negative signal trace 112 from the left of the figure to crossover point 206 is equal in magnitude and opposite in sign to the radiant effects of current of positive signal trace 106 as felt by positive signal trace 110 crossover point 206 to the right of the figure. Accordingly, the radiant effects of the current from the left side of the figure to the right side of the figure cancel each other out. Canceling the radiant effects is the purpose or goal of performing the crossover in differential pairs. Conventionally, crossovers are formed by “tunneling” below one of the signal traces. This will be further described with additional reference to FIGS. 3A-E.

FIGS. 3A-E illustrate cross-sectional views of the example conventional transmission line system of FIG. 2.

FIG. 3A is a cross-sectional view of conventional transmission line system 200 at a cross section 202 as illustrated in FIG. 2.

As shown in FIG. 3A, conventional transmission line system 200 includes a dielectric 306 surrounding positive signal trace 106, negative signal trace 108, positive signal trace 110 and negative signal trace 112. Dielectric 306 includes a top surface 302 and a bottom surface 304.

Negative signal trace 108 is located to the right of positive signal trace 106. Positive signal trace 110 is located to the right of negative signal trace 108. Negative signal trace 112 is located to the right of positive signal trace 110. Signal traces 106, 108, 110 and 112 are located in a horizontal plane 308.

At some point, positive signal trace 110 needs to switch places with negative signal trace 112. As the positive signal trace 110 cannot contact negative signal trace 112, one of the signal traces needs to transition to another plane. This will be described with reference to FIG. 3B.

FIG. 3B is a cross-sectional view of conventional transmission line system 200 at a cross section 204 as illustrated in FIG. 2.

As shown in FIG. 38, a via 310 enables negative signal trace 112 to transition from horizontal plane 308 to a horizontal plane 312. Once at horizontal plane 312, negative signal trace 112 and positive signal trace 110 may switch places. This will be described with reference to FIG. 3C.

FIG. 3C is a cross-sectional view of conventional transmission line system 200 at crossover point 206 as illustrated in FIG. 2.

From cross section 204 to a cross section 208, positive signal trace 110 is located in a different plane than that of negative signal trace 112. As shown in FIG. 3C, at the point of crossing over at crossover point 206, positive signal trace 110 is located above negative signal trace 112 and the signal traces are vertically located between the positions as described with reference to FIGS. 3A-B. Positive signal trace 110 is horizontally located in horizontal plane 308 and negative signal trace 112 is horizontally located in horizontal plane 312.

The signal traces eventually transition to their respective planes. This will be described with reference to FIG. 3D.

FIG. 3D is a cross-sectional view of conventional transmission line system 200 at cross section 208 as illustrated in FIG. 2.

As shown in FIG. 3D, a via 314 enables negative signal trace 112 to transition from horizontal plane 312 back to horizontal plane 308. Once at horizontal plane 308, negative signal trace 112 and positive signal trace 110 may continue. This will be described with reference to FIG. 3E.

FIG. 3E is a cross-sectional view of conventional transmission line system 200 at a cross section 210 as illustrated in FIG. 2.

As shown in FIG. 3E, negative signal trace 108 is located to the right of positive signal trace 106. Positive signal trace 110 is located to the right of negative signal trace 108. Negative signal trace 112 is located to the right of positive signal trace 110. Signal traces 106, 108, 110 and 112 are located in horizontal plane 308. The size, characteristic impedance and geometry of vias negatively impact crosstalk between differential pairs in an attempt to reduce crosstalk.

Crosstalk reduction is attempted by crossing positive signal trace 110 and negative signal trace 112. However, due to the size, structure and characteristic impedance of vias, transitioning signal traces between layers using vias generates its own distortion, which may typically be significantly larger than that as created by crosstalk. The net result of crossing signal traces using vias may therefore achieve little signal improvement.

What is needed is a system and method for decreasing crosstalk associated with differential pairs.

### BRIEF SUMMARY

The present invention provides a system and method for decreasing crosstalk associated with differential pairs.

The present invention provides a device for use with a signal, wherein the device includes a substrate, a first signal trace and a second signal trace. The first signal trace is disposed within the substrate at a first plane from the top surface by a distance d₁. The second signal trace is disposed within the substrate at a second plane from the top surface by a distance d₂, wherein d₂<d₁<t. The first signal trace includes a first portion, whereas the second signal trace includes a second portion. The first portion is parallel to the second portion. The first signal trace and the second signal trace form a differential pair. The first signal trace is operable to conduct a positive portion of the signal, whereas the second signal trace is operable to conduct a negative portion of the signal.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIGS. 1A-C illustrates an example conventional transmission line system 100;

FIG. 2 illustrates an example conventional transmission line system 200, wherein one set of signal traces include a crossover;

FIGS. 3A-E illustrate a cross-sectional view of the example conventional transmission line system of FIG. 2;

FIG. 4 illustrates an example transmission line system, in accordance with an aspect of the present invention;

FIGS. 5A-D illustrate cross sections for the example transmission line system as described with reference to FIG. 4, in accordance with an aspect of the present invention;

FIGS. 6A-K illustrate a method for fabrication of an example transmission line system 600, in accordance with an aspect of the present invention; and

FIG. 7 illustrates a method for fabrication of an example transmission line system as described with reference to FIG. 4-6, in accordance with an aspect of the present invention.

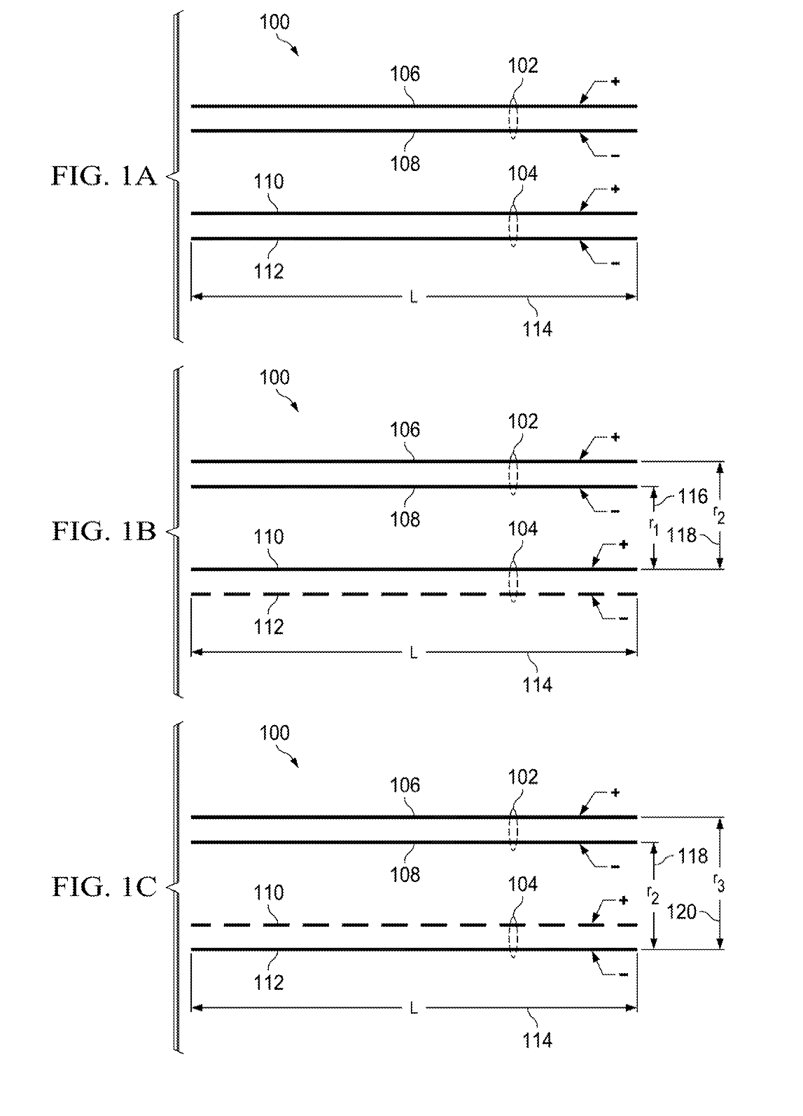

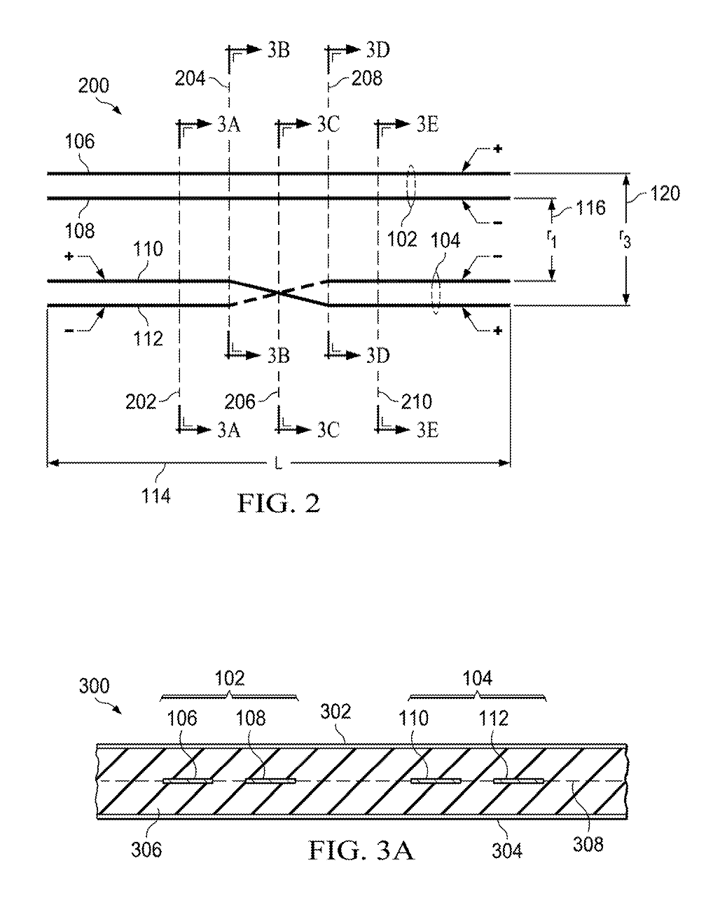

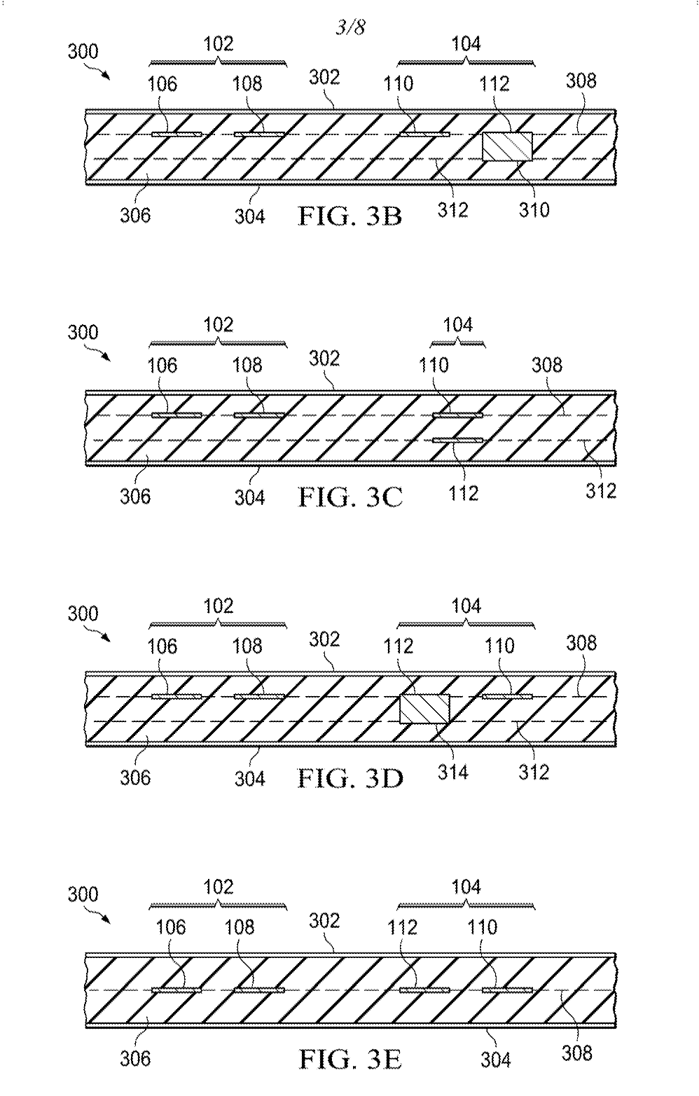

### DETAILED DESCRIPTION

In accordance with aspects of the present invention, a system and method for reducing crosstalk associated with differential pairs via crossing of signal traces is presented.

Example aspects of the present invention will now be described in greater detail with reference to FIGS. 4-7.

FIG. 4 illustrates an example transmission line system 400, in accordance with an aspect of the present invention.

Transmission line system 400 includes a differential pair 402 and a differential pair 404.

Differential pair 402 provides a transmission medium for transferring an electrical signal. Differential pair 404 provides a transmission medium for transferring an electrical signal.

Differential pair 402 includes a signal trace 406 and a signal trace 408. Differential pair 404 includes a signal trace 410 and a signal trace 412.

Signal trace 406 and signal trace 408 provide transference of an electrical signal with the current flowing in signal trace 406 being in the opposite direction of signal trace 408. Signal trace 410 and signal trace 412 provide transference of an electrical signal with the current flowing in signal trace 410 being in the opposite direction of signal trace 412.

Signal trace 410 and signal trace 412 swap paths at a cross section 416 with the signal traces as located at a cross section 414 being located in opposite paths as at a cross section 418.

Signal trace 406 and signal trace 408 swap paths at a cross section 420 with the signal traces as located at cross section 418 being located in opposite paths as at a cross section 422.

Switching signal trace 406 and signal trace 408 and switching signal trace 410 and signal trace 412 balances the mutual coupling between differential pair 402 and 404 such that the total current through the cross section of the differential pairs is reduced thereby reducing crosstalk between the differential pairs.

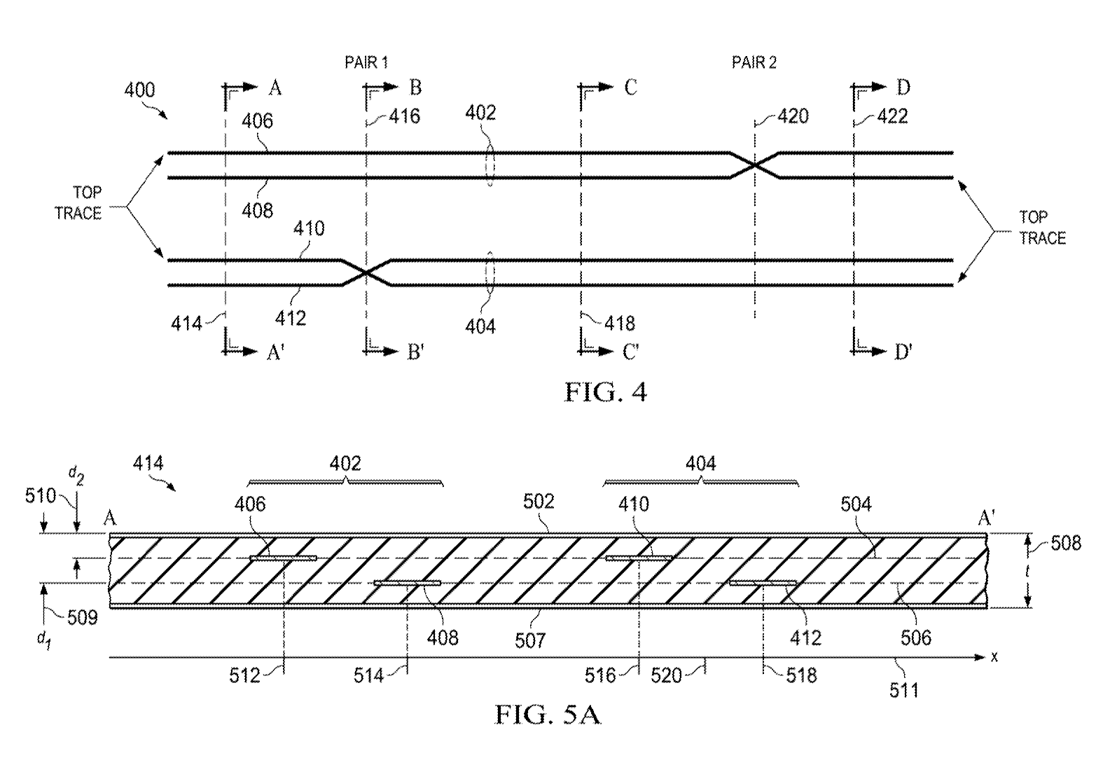

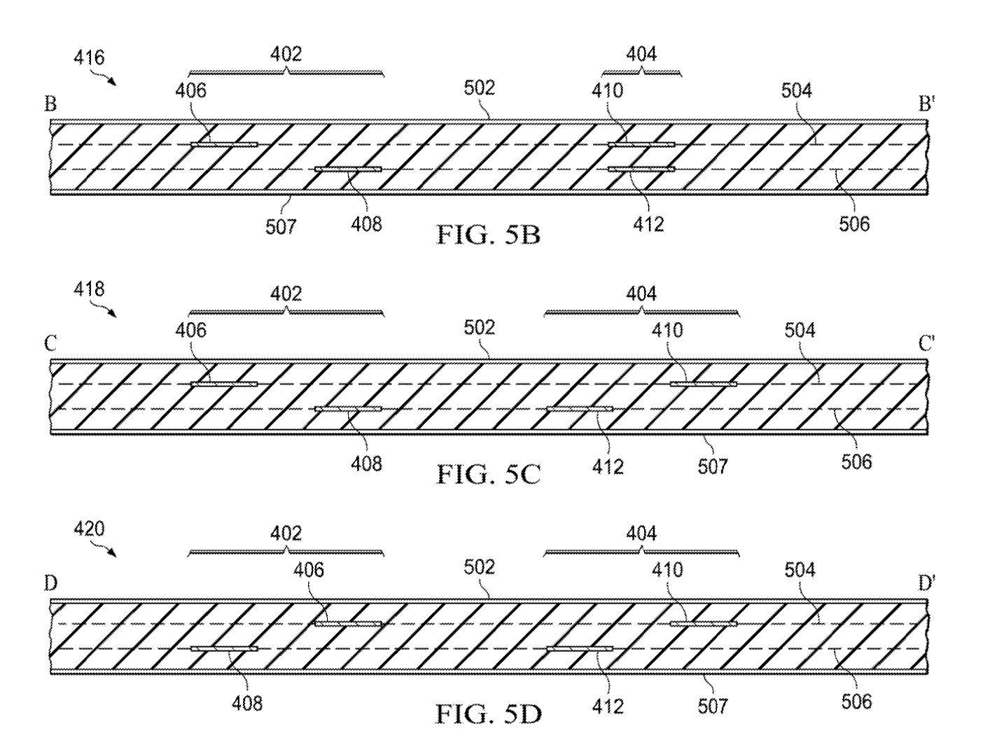

FIGS. 5A-D illustrates cross-sectional views of example transmission line system 400 of FIG. 4.

FIG. 5A represents cross section 414 along line A-A′ as described with reference to FIG. 4.

Cross section 414 includes differential pair 402, differential pair 404, signal trace 406, signal trace 408, signal trace 410, signal trace 412, a top surface 502, a signal plane 504, a signal plane 506 and a bottom surface 507.

Top surface 502 is located on top and above signal plane 504. Bottom surface 507 is located on the bottom. Top surface 502 is separated from bottom surface 507 by a distance 508 also noted as t. Signal plane 506 is located above bottom surface 507 and is located below top surface 502 by a distance 509 also noted as d₁. Signal plane 504 is located above signal plane 506 and is located below top surface 502 by a distance 510 also noted as Signal plane 506 is located above bottom surface 507 and is located below top surface 502 by a distance 510 also noted as d₂. Furthermore, the distances satisfy d₂<d₁<t.

In some embodiments, top surface 502 and bottom surface 507 may provide an electrical path to ground. Signal plane 504 and 506 provide an avenue for traversing signal traces.

Signal trace 406 is located in signal plane 504 at a location 512 with respect to an x-axis 511. Signal trace 408 is located in signal plane 506 at a location 514 with respect to x-axis 511. Signal trace 410 is located in signal plane 504 at a location 516 with respect to x-axis 511. Signal trace 412 is located in signal plane 506 at a location 518 with respect to x-axis 511.

FIG. 5B represents cross section 416 along line B-B′ as described with reference to FIG. 4.

Signal traces 406 and 408 are located at the same x-axis location and in the same signal plane as described with reference to FIG. 5A.

For cross section 416, signal traces 410 and 412 are located at a location 520 with respect to x-axis 511. Furthermore, signal traces 410 and 412 are located in the same signal planes as described with reference to FIG. 5A. The x-axis location 520 is located between location 516 and location 518.

Signal trace 410 overlaps signal trace 412.

FIG. 5C represents cross section 418 along line C-C′ as described with reference to FIG. 4.

For cross section 418, signal traces 406 and 408 are located at the same x-axis location and in the same signal plane as described with reference to FIGS. 5A-B.

Signal trace 410 is located at location 518 and signal trace 412 is located at location 516. Signal traces 410 and 412 are located in the same signal planes as described with reference to FIGS. 5A-B.

In FIG. 5C, signal trace 410 and signal trace 412 have swapped horizontal locations as compared to FIG. 5A. Swapping signal traces enables the balancing mutual coupling between differential pair 402 and differential pair 404 which reduces the total current through the cross section of the differential pairs which reduces the crosstalk between the differential pairs.

FIG. 5D represents cross section 422 along line D-D′ as described with reference to FIG. 4.

For cross section 420, signal traces 410 and 412 are located at the same location and as described with reference to FIG. 5C. Signal traces 410 and 412 are located in the same signal planes as described with reference to FIGS. 5A-C.

Signal trace 406 is located at location 514 and signal trace 408 is located at location 512 and is opposite as described with reference to FIGS. 5A-C. Signal traces 406 and 408 are located in the same signal planes as described with reference to FIGS. 5A-C. Swapping signal traces enables the balancing mutual coupling between differential pair 402 and differential pair 404 which reduces the total current through the cross section of the differential pairs which reduces the crosstalk between the differential pairs.

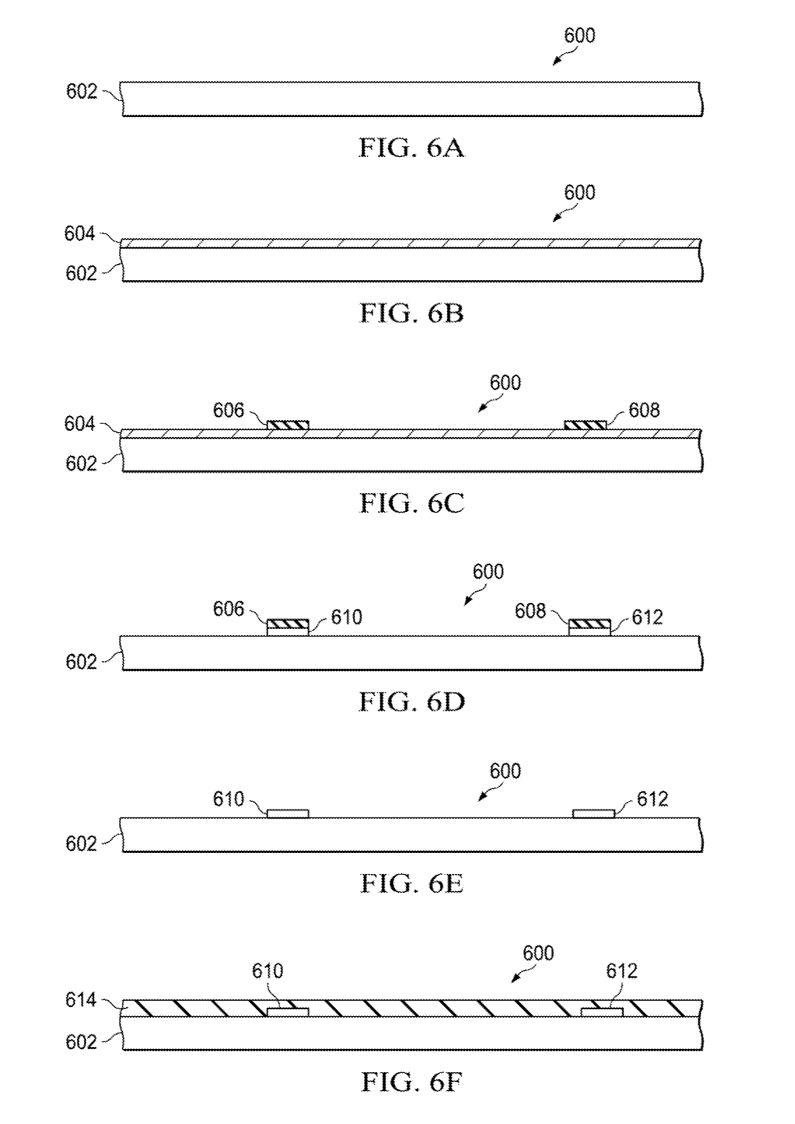

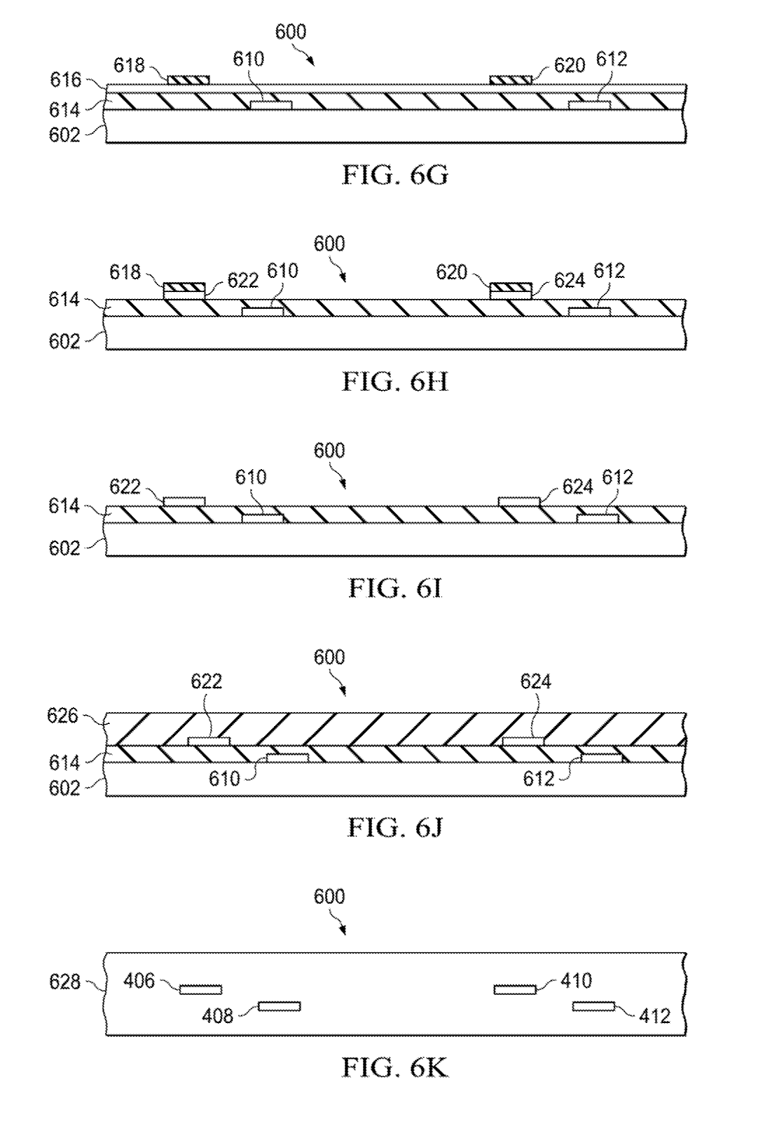

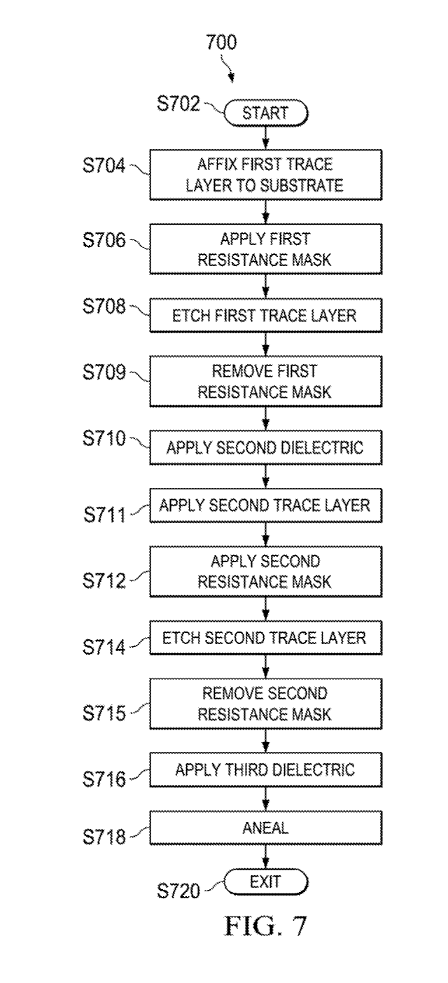

A process for fabricating the example transmission line system described with reference to FIGS. 4-5 will now be presented with additional reference to FIGS. 6-7.

FIGS. 6A-J illustrate a method for fabrication of an example transmission line system 600, in accordance with an aspect of the present invention. FIG. 7 illustrates a method 700 for fabrication of an example transmission line system as described with reference to FIG. 4-6, in accordance with an aspect of the present invention.

The fabrication method as described in FIGS. 6A-J generates a transmission line system which reduces crosstalk between differential pairs by crossing of signal traces and which does not use vias for transitioning between layers, as vias negatively affect crosstalk between differential pairs.

In FIG. 6A, a substrate 602 is provided. As shown in FIG. 7, method 700 starts (S702) by affixing a first trace layer to a substrate layer (S704). For example, returning to FIG. 6B a trace layer 604 is applied on top of substrate 602. Trace layer 604 may be any known electrically conductive material, non-limiting examples of which include Au, Ag and Cu.

Returning to FIG. 7, a first resistance mask is added to the first dielectric layer (S706). For example, as shown in FIG. 6C, a resistance mask 606 and a resistance mask 608 are applied on top of trace layer 604. A non-limiting example for resistance masks 606 and 608 is photo-resist or chemical-resist mask.

Returning to FIG. 7, etching is applied to first trace layer leaving material beneath first resistance mask (S708). For example, as shown in FIG. 6D, the configuration described with reference to FIG. 6C has been etched, wherein portions of trace layer 604 not covered by resistance masks 606 and 608 is etched away. Furthermore, etching process leaves a signal trace 610 and a signal trace 612.

Returning to FIG. 7, first resistance mask is removed (S709). For example, as shown in FIG. 6E, resistance masks 606 and 608 (as shown in FIG. 6D) are removed, leaving signal traces 610 and 612.

Returning to FIG. 7, a second dielectric layer is applied (S710). For example, as shown in FIG. 6F, a dielectric 614 has been placed on top of substrate 602, signal trace 610 and signal trace 612. Dielectric 614 may be fabricated of a dielectric material which is the same material or is a similar material as substrate 602.

Returning to FIG. 7, a second trace layer is applied (S711). In FIG. 6G, the process described with reference to FIGS. 6B-D is repeated. A trace layer 616 is disposed on dielectric 614. Trace layer 616 is fabricated of an electrically conductive material. For example, returning to FIG. 6F, trace layer 616 is applied on top of dielectric 614.

Returning to FIG. 7, a second resistance mask is applied to second dielectric layer (S712). For example, as shown in FIG. 6G, a resistance mask 618 and a resistance mask 620 are disposed on trace layer 616.

Returning to FIG. 7, an etching process is applied to second trace layer leaving traces located beneath resistance mask (S714). For example, as shown in FIG. 6H, the configuration described with reference to FIG. 6G has been etched such that portions of trace layer 616 not covered by resistance masks 618 and 620 are removed. Furthermore, etching process leaves a signal trace 622 and a signal trace 624.

Returning to FIG. 7, second resistance mask is removed (S715). For example, as shown in FIG. 6I, the configuration as described with reference to FIG. 6H is processed so as to remove resistance masks 618 and 620, leaving signal traces 622 and 624.

Returning to FIG. 7, a third dielectric layer is applied (S716). For example, as shown in FIG. 6J, a dielectric 626 is disposed on signal trace 622, signal trace 624 and dielectric 614. Dielectric 626 may be fabricated of a dielectric material and may be the same or similar as substrate 602 and dielectric 614

Returning to FIG. 7, an annealing process is applied (S718). For example, as shown in FIG. 6K, an annealing process is applied to the configuration as described with reference to FIG. 6J. The annealing process forms a layer 628 which includes the combination of dielectric 626, dielectric 614 and substrate 602 into a single layer. Signal traces 406, 408, 410 and 412 are disposed within layer 628.

At this point method 700 is complete (S720).

A signal trace configuration in accordance with the present invention allows for low insertion loss in signal traces for performing a crossover in a differential pair. Furthermore, the signal trace configuration increases performance as it reduces the use of vias for performing crossovers, as vias generate distortion of signals due to the size, structure and characteristic impedance associated with vias. Furthermore, the signal trace configuration provides crosstalk reduction up to the maximum operating frequency of the transmission line. Furthermore, the signal trace configuration enables multiple crossover types to coexist without requiring a significant amount of real estate as is the case with conventional technology which uses a multiplicity of vias for performing the crossovers.

The use of vias in conventional technology is complicated and performed by transitioning a signal from one plane to another plane, swapping the signal traces while in different planes, and then transitioning the signal back to the original plane using a via. Furthermore, issues associated with low insertion loss crossovers for reducing crosstalk due to discontinuities introduced by vias is improved by performing the crossovers on alternate layers thereby reducing the use of vias for performing the crossovers. Furthermore, the signal trace configuration reduces crosstalk and as a result increases system performance. Furthermore, since devices do not use vias for switching signals, as in the case of conventional technology, fabrication of devices for swapping signal traces is easier than as compared to conventional configurations which use vias for swapping signals.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a signal, said device comprising:
a substrate having a top surface and a bottom surface, said top surface being separated from said bottom surface by a thickness t;
a first signal trace disposed within said substrate at a first plane from said top surface by a distance d₁; and
a second signal trace disposed within said substrate at a second plane from said top surface by a distance d₂,
wherein said first signal trace includes a first portion,
wherein said second signal trace includes a second portion,
wherein said first portion is parallel to said second portion,
wherein said first signal trace and said second signal trace form a differential pair,
wherein said first signal trace is operable to conduct a positive portion of the signal,
wherein said second signal trace is operable to conduct a negative portion of the signal,
wherein d₂<d₁<t.

2. The device of claim 1,
wherein said first signal trace additionally includes a third portion,
wherein said second signal trace additionally includes a fourth portion, and
wherein said third portion is parallel to said fourth portion.

3. The device of claim 2,
wherein said first signal trace additionally includes a fifth portion,
wherein said second signal trace additionally includes a sixth portion,
wherein said fifth portion is not parallel to said sixth portion,
wherein said fifth portion is in connection with said first portion and said third portion; and
wherein said sixth portion is in connection with said second portion and said fourth portion.

4. A method of forming a device having a differential pair for conducting a signal, said method comprising:
forming a first substrate layer;
forming a first signal trace on the first substrate layer;
forming a second substrate layer on the first substrate layer and the first signal trace; and
forming a second signal trace on the second substrate layer,
wherein said forming a first signal trace on the first substrate layer comprises forming the first signal trace to include a first portion,
wherein said forming a second signal trace on the second substrate layer comprises forming the second signal trace to include a second portion,
wherein the first portion is parallel to the second portion,
wherein the first signal trace and the second signal trace form the differential pair,
wherein the first signal trace is operable to conduct a positive portion of the signal, and
wherein the second signal trace is operable to conduct a negative portion of the signal.

5. The method of claim 4,
wherein said forming a first signal trace on the first substrate layer comprises forming the first signal trace to additionally include a third portion,
wherein said forming a second signal trace on the second substrate layer comprises forming the second signal trace to additionally include a fourth portion, and
wherein the third portion is parallel to the fourth portion.

6. The method of claim 5,
wherein said forming a first signal trace on the first substrate layer comprises forming the first signal trace to additionally include a fifth portion,
wherein said forming a second signal trace on the second substrate layer comprises forming the second signal trace to additionally include a sixth portion, and
wherein the fifth portion is not parallel to the sixth portion,
wherein the fifth portion is in connection with the first portion and the third portion; and
wherein the sixth portion is in connection with the second portion and the fourth portion.
